(19) United States
(12) Patent Application Publication
(10) Pub. No.: US 2020/0201032 A1
(43) Pub. Date: Jun. 25, 2020

(54) IMAGE PICKUP DEVICE AND AUTOMATIC CLEANING ASSEMBLY THEREOF

(71) Applicant: Primax Electronics Ltd., Taipei (TW)

(72) Inventors: Chiao-Lin Chang, Taipei (TW); Wen-Pin Hsieh, Taipei (TW); Yi-Ching Tsai, Taipei (TW); Nai-Cheng Chou, Taipei (TW)

(21) Appl. No.: 16/362,414

(22) Filed: Mar. 22, 2019

(30) Foreign Application Priority Data
Dec. 19, 2018 (TW) 107145947

(51) Int. Cl. G02B 27/00; H04N 5/225; G03B 17/56

(52) U.S. Cl. CPC G02B 27/0006; G03B 17/568; H04N 5/2254

(57) ABSTRACT

An image pickup device includes a camera module and an automatic cleaning assembly. The automatic cleaning assembly includes a first rotation structure, a second rotation structure and a motive power source. A first end of a light-transmissible film is connected with the first rotation structure. A second end of the light-transmissible film is connected with the second rotation structure. The motive power source drives the rotation of at least one of the first rotation structure and the second rotation structure. As the at least one of the first rotation structure and the second rotation structure is rotated, the light-transmissible film is correspondingly moved. Consequently, the front side of the camera module is covered by a clean segment of the light-transmissible film.

### FIELD OF THE INVENTION

The present invention relates to an optical field, and more particularly to an image pickup device.

### BACKGROUND OF THE INVENTION

Recently, with the development of electronic industries and the advance of industrial technologies, various electronic devices are designed toward small size, light weightiness and easy portability. Consequently, these electronic devices can be applied to mobile business, entertainment or leisure purposes whenever or wherever the users are. For example, various camera modules are widely used in many kinds of fields such as smart phones, wearable electronic devices or any other appropriate portable electronic devices. Since the electronic devices are small and portable, the users can take the electronic devices to capture images and store the images according to the users' requirements. Alternatively, the images can be uploaded to the internet through mobile networks. In other words, these electronic devices not only have important commercial values but also provide more colorful lives to people. In addition to the applications on the portable electronic devices, most camera modules are applied to the vehicular electronic devices in order to meet the high safety requirements.

Generally, the camera module comprises a lens module and a sensing chip. The lens module is used for refracting the external light beams and allowing the external light beam to pass through. After the external light beams passing through the lens module are received by the sensing chip, an image is produced. For increasing the quality of the image, the lens module and the sensing chip need to be clean and dustless. Since the sensing chip is packaged within the camera module, the sensing chip is not vulnerable to dust pollution. Consequently, it is important to clean the lens module.

Conventionally, the lens module is cleaned through a water-spraying process and a scraper. However, if the viscosity of the contaminant is high, the contaminant is unable to be completely cleaned off by the water-spraying process and the scraper, and the lens module is readily damaged. Moreover, if the lens module of the camera module is contaminated during the process of driving the vehicle, the task of cleaning the lens module has to be performed immediately. For increasing the safety of driving the vehicle, the camera module has to continuously capture the image during the process of cleaning the image pickup device, and the task of continuously capturing the image cannot interfered by the cleaning process.

### SUMMARY OF THE INVENTION

The present invention provides an image pickup device. The image pickup device is equipped with a light-transmissible film to protect a camera module from dust and/or dirt. If the contamination level of a segment of the light-transmissible film corresponding to the front side of the camera module is high, the light-transmissible film is moved and front side of the lens module is covered by a next clean segment of the light-transmissible film. During the process of cleaning the image pickup device, the camera module can continuously capture the image without being interfered by the cleaning process.

In accordance with an aspect of the present invention, there is provided an automatic cleaning assembly for cleaning a camera module. The automatic cleaning assembly includes a first rotation structure, a second rotation structure and a motive power source. A first end of a light-transmissible film is connected with the first rotation structure. A second end of the light-transmissible film is connected with the second rotation structure. The camera module is arranged between the first rotation structure and the second rotation structure. A front side of the camera module is covered by a first segment of the light-transmissible film. The motive power source drives a rotation of at least one of the first rotation structure and the second rotation structure. During the rotation of the at least one of the first rotation structure and the second rotation structure, the first segment of the light-transmissible film is moved toward the second rotation structure and the front side of the camera module is covered by a second segment of the light-transmissible film.

In accordance with another aspect of the present invention, there is provided an image pickup device. The image pickup device includes a camera module and an automatic cleaning assembly. The camera module includes a lens module and a sensing chip. After plural light beams passing through the lens module are sensed by the sensing chip, an image is produced. The automatic cleaning assembly includes a first rotation structure, a second rotation structure and a motive power source. A first end of a light-transmissible film is connected with the first rotation structure. A second end of the light-transmissible film is connected with the second rotation structure. The camera module is arranged between the first rotation structure and the second rotation structure. A front side of the camera module is covered by a first segment of the light-transmissible film. The motive power source drives a rotation of at least one of the first rotation structure and the second rotation structure. During the rotation of the at least one of the first rotation structure and the second rotation structure, the first segment of the light-transmissible film is moved toward the second rotation structure and the front side of the camera module is covered by a second segment of the light-transmissible film.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic view illustrating the structure of an image pickup device according to an embodiment of the present invention; and

FIG. 2 is a schematic view illustrating the structure of the image pickup device of FIG. 1 while a light-transmissible film is moved.

### DETAILED DESCRIPTION OF THE PREFERRED EMBODIMENT

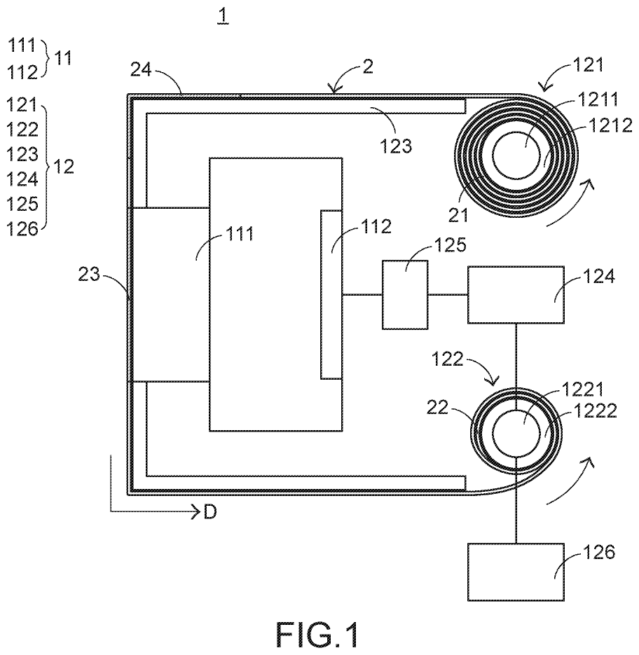

FIG. 1 is a schematic view illustrating the structure of an image pickup device according to an embodiment of the present invention. The image pickup device 1 comprises a camera module 11 and an automatic cleaning assembly 12.

The camera module 11 comprises a lens module 111 and a sensing chip 112. The lens module 111 is used for refracting the external light beams and allowing the external light beam to pass through. After the external light beams passing through the lens module 111 are received by the sensing chip 112, an image is produced.

The automatic cleaning assembly 12 comprises a first rotation structure 121, a second rotation structure 122, a supporting structure 123 and a motive power source 124. A first end 21 and a second end 22 of a light-transmissible film 2 are connected with the first rotation structure 121 and the second rotation structure 122, respectively. The camera module 11 is arranged between the first rotation structure 121 and the second rotation structure 122. In addition, a front side of the lens module 111 is covered by the light-transmissible film 2. As show in FIG. 1, the front side of the lens module 111 is covered by a first segment 23 of the light-transmissible film 2. The supporting structure 123 is used for supporting the portion of the light-transmissible film 2 that is arranged between the first rotation structure 121 and the second rotation structure 122. The motive power source 124 is used for driving the rotation of at least one of the first rotation structure 121 and the second rotation structure 122. Consequently, the light-transmissible film 2 is movable on the supporting structure 123.

In an embodiment, the first rotation structure 121 comprises a first rotating shaft 1211 and a first roller 1212. The first rotating shaft 1211 is penetrated through the first roller 1212. When the light-transmissible film 2 has not been used and the light-transmissible film 2 is clean, the light-transmissible film 2 is wound around the first roller 1212. The second rotation structure 122 comprises a second rotating shaft 1221 and a second roller 1222. The second rotating shaft 1221 is penetrated through the second roller 1222. After the light-transmissible film 2 is used and a contamination level of the light-transmissible film 2 exceeds a specified level, the contaminated portion of the light-transmissible film 2 is wound around the second roller 1222. In an embodiment, the motive power source 124 is a motor. The second rotating shaft 1221 is connected with the motive power source 124 to receive the motive power from the motive power source 124. The second rotating shaft 1221 is rotated in response to the motive power. As the second rotating shaft 1221 is rotated, the second roller 1222 is correspondingly rotated. Consequently, the light-transmissible film 2 is moved toward the second rotation structure 122 in the direction D and retracted to the second rotation structure 122. In this embodiment, the first rotating shaft 1211 and the first roller 1212 may be considered as a driven shaft and a driven roller, respectively. In addition, the second rotating shaft 1221 and the second roller 1222 may be considered as a drive shaft and a drive roller, respectively.

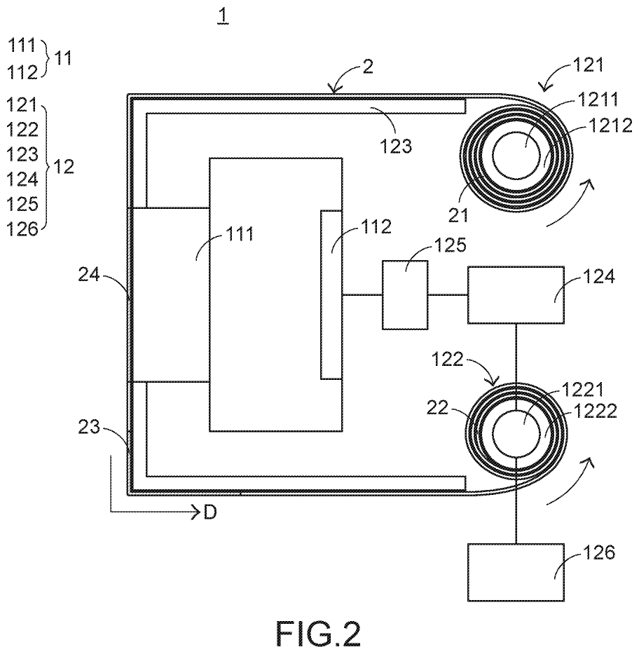

In this embodiment, the automatic cleaning assembly 12 further comprises a contamination judgement element 125. The contamination judgement element 125 is electrically connected with the motive power source 124. The contamination judgement element 125 is used for judging the contamination level of the portion of the light-transmissible film 2 that covers the front side of the lens module 111. For example, as shown in FIG. 1, the contamination judgement element 125 judges that the contamination level of the first segment 23 of the light-transmissible film 2 exceeds a specified level. According to the judging result of the contamination judgement element 125, the motive power source 124 drives the rotation of the second rotating shaft 1221 of the second rotation structure 122. As the second rotating shaft 1221 is rotated, the first segment 23 of the light-transmissible film 2 is moved toward the second rotation structure 122 in the direction D and departed from the front side of the lens module 111. Correspondingly, as shown in FIG. 2, the front side of the lens module 111 is covered by a clean portion (e.g., a second segment 24) of the light-transmissible film 2.

In an embodiment, if a contamination area of the portion of the light-transmissible film 2 that covers the front side of the lens module 111 (e.g., the first segment 23 as shown in FIG. 1) exceeds a specified percentage of a visible region of the camera module 11, the contamination judgement element 125 judges that the contamination level exceeds the specified level. According to the judging result of the contamination judgement element 125, the motive power source 124 drives the rotation of the second rotating shaft 1221 of the second rotation structure 122.

In an embodiment, the contamination judgement element 125 is installed in the camera module 11 and electrically connected with the sensing chip 112. Moreover, according to a resolution of plural pixels of the image that is captured by the camera module 11, the contamination judgement element 125 obtains the contamination area. For example, the area corresponding to the pixels with the resolution lower than a specified value is considered as the contamination area. Then, the percentage of the contamination area with respect to the visible region of the camera module 11 is calculated. According to the calculation result, the contamination level of the first segment 23 of the light-transmissible film 2 is obtained. The way of judging the contamination level of the first segment 23 of the light-transmissible film 2 is presented herein for purpose of illustration and description only. It is noted that numerous modifications and alterations may be made while retaining the teachings of the invention.

Furthermore, the first roller 1212 of the first rotation structure 121, the second roller 1222 of the second rotation structure 122 and the light-transmissible film 2 are replaceable components. When the light-transmissible film 2 has no clean segments or the length of the unused portion of the light-transmissible film 2 (i.e., the available length of the clean light-transmissible film 2) is smaller than a specified length, the first roller 1212, the second roller 1222 and the light-transmissible film 2 between the first roller 1212 and the second roller 1222 may be removed from the automatic cleaning assembly 12 by the user. Then, another first roller 1212, another second roller 1222 and another light-transmissible film 2 are installed on the automatic cleaning assembly 12. Alternatively, after the light-transmissible film 2 is removed from the first roller 1212 and the second roller 1222, another light-transmissible film 2 is installed on the first roller 1212 and the second roller 1222.

In an embodiment, the automatic cleaning assembly 12 further comprises a length detector 126 for detecting the length of the unused portion of the light-transmissible film 2 (i.e., the available length of the clean light-transmissible film 2). If the length of the unused portion of the light-transmissible film 2 is smaller than the specified length, the length detector 126 issues a prompt signal to prompt the user to perform the above replacing process. In an embodiment, the length detector 126 is electrically connected with the second rotating shaft 1221 of the second rotation structure 122. By detecting the rotation amount of the second rotating shaft 1221, the length detector 126 estimates the length of the unused portion of the light-transmissible film 2.

In another embodiment, at least one segment of the light-transmissible film 2 is equipped with an available length mark to prompt the user of the information about the length of the unused portion of the light-transmissible film 2.

It is noted that the method of detecting the length of the unused portion of the light-transmissible film 2 and the method of prompting the user are not restricted. According to the practical requirements, numerous modifications and alterations may be made by those skilled in the art.

From the above descriptions, the present invention provides the image pickup device 1. The front side of the lens module 111 is covered by the light-transmissible film 2. The light-transmissible film 2 is used for protecting the lens module 111 from contaminant such as dust and dirt. If the contamination level of the portion of the light-transmissible film 2 exceeds the specified level, the motive power source 124 is automatically enabled to drive the rotation of at least one of the first rotation structure 121 and the second rotation structure 122. Consequently, the portion of the light-transmissible film 2 between the first rotation structure 121 and the second rotation structure 122 is moved. After the segment of the light-transmissible film 2 with the contamination level is departed from the front side of the lens module 111, and the front side of the lens module 111 is covered by a next clean segment of the light-transmissible film 2. During the process of cleaning the image pickup device 1, the camera module 11 can continuously capture the image without being interfered by the cleaning process. In other words, the automatic cleaning assembly of the present invention is industrially valuable. Especially, the automatic cleaning assembly of the present invention is suitably applied to vehicular image pickup devices in order to meet the high safety requirements. It is noted that the applications of the automatic cleaning assembly are not restricted. For example, the automatic cleaning assembly is also suitably applied to outdoor image pickup devices because the operating environment is prone to contamination.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. An automatic cleaning assembly for cleaning a camera module, the automatic cleaning assembly comprising:
a first rotation structure, wherein a first end of a light-transmissible film is connected with the first rotation structure;
a second rotation structure, wherein a second end of the light-transmissible film is connected with the second rotation structure, wherein the camera module is arranged between the first rotation structure and the second rotation structure, and a front side of the camera module is covered by a first segment of the light-transmissible film; and
a motive power source driving a rotation of at least one of the first rotation structure and the second rotation structure,
wherein during the rotation of the at least one of the first rotation structure and the second rotation structure, the first segment of the light-transmissible film is moved toward the second rotation structure and the front side of the camera module is covered by a second segment of the light-transmissible film.

2. The automatic cleaning assembly according to claim 1, wherein the first rotation structure comprises a first rotating shaft and a first roller, and the first rotating shaft is penetrated through the first roller, wherein when the light-transmissible film has not been used, the light-transmissible film is wound around the first roller.

3. The automatic cleaning assembly according to claim 2, wherein at least one of the first roller and the light-transmissible film is replaceable.

4. The automatic cleaning assembly according to claim 1, wherein the second rotation structure comprises a second rotating shaft and a second roller, and the second rotating shaft is penetrated through the second roller to receive a motive power from the motive power source, wherein after the light-transmissible film is used, the light-transmissible film is wound around the second roller.

5. The automatic cleaning assembly according to claim 4, wherein at least one of the second roller and the light-transmissible film is replaceable.

6. The automatic cleaning assembly according to claim 1, wherein the automatic cleaning assembly further comprises a contamination judgement element, and the contamination judgement element is electrically connected with the motive power source, wherein if the contamination judgement element judges that a contamination level of the first segment of the light-transmissible film exceeds a specified level, the motive power source is enabled to drive the rotation of the at least one of first rotation structure and the second rotation structure.

7. The automatic cleaning assembly according to claim 6, wherein if a contamination area of the first segment of the light-transmissible film exceeds a specified percentage of a visible region of the camera module, the contamination judgement element judges that the contamination level exceeds the specified level.

8. The automatic cleaning assembly according to claim 7, wherein the contamination judgement element judges whether the contamination area exceeds the specified percentage of the visible region of the camera module according to at least one resolution of an image captured by the camera module.

9. The automatic cleaning assembly according to claim 1, wherein the automatic cleaning assembly further comprises a length detector, and a length of an unused portion of the light-transmissible film is detected by the length detector.

10. The automatic cleaning assembly according to claim 1, wherein the automatic cleaning assembly further comprises a supporting structure, wherein the light-transmissible film is supported by the supporting structure, and the light-transmissible film is movable on the supporting structure.

11. An image pickup device, comprising:
a camera module comprising a lens module and a sensing chip, wherein after plural light beams passing through the lens module are sensed by the sensing chip, an image is produced; and
an automatic cleaning assembly comprising:
a first rotation structure, wherein a first end of a light-transmissible film is connected with the first rotation structure;
a second rotation structure, wherein a second end of the light-transmissible film is connected with the second rotation structure, wherein the camera module is arranged between the first rotation structure and the second rotation structure, and a front side of the camera module is covered by a first segment of the light-transmissible film; and
a motive power source driving a rotation of at least one of the first rotation structure and the second rotation structure,
wherein during the rotation of the at least one of the first rotation structure and the second rotation structure, the first segment of the light-transmissible film is moved toward the second rotation structure and the front side of the camera module is covered by a second segment of the light-transmissible film.

12. The image pickup device according to claim 11, wherein the first rotation structure comprises a first rotating shaft and a first roller, and the first rotating shaft is penetrated through the first roller, wherein when the light-transmissible film is used, the light-transmissible film is wound around the first roller.

13. The image pickup device according to claim 11, wherein the second rotation structure comprises a second rotating shaft and a second roller, and the second rotating shaft is penetrated through the second roller to receive a motive power from the motive power source, wherein after the light-transmissible film is used, the light-transmissible film is wound around the second roller.

14. The image pickup device according to claim 11, wherein the automatic cleaning assembly further comprises a contamination judgement element, and the contamination judgement element is electrically connected with the motive power source, wherein if the contamination judgement element judges that a contamination level of the first segment of the light-transmissible film exceeds a specified level, the motive power source is enabled to drive the rotation of the at least one of first rotation structure and the second rotation structure.

15. The image pickup device according to claim 14, wherein if a contamination area of the first segment of the light-transmissible film exceeds a specified percentage of a visible region of the camera module, the contamination judgement element judges that the contamination level exceeds the specified level.

16. The image pickup device according to claim 15, wherein the contamination judgement element judges whether the contamination area exceeds the specified percentage of the visible region of the camera module according to at least one resolution of the image.

17. The image pickup device according to claim 11, wherein the automatic cleaning assembly further comprises a length detector, and a length of an unused portion of the light-transmissible film is detected by the length detector.

18. The image pickup device according to claim 11, wherein the image pickup device is a vehicular image pickup device, or the image pickup device is an outdoor image pickup device.
